(19) United States
(12) Patent Application Publication
(10) Pub. No.: US 2026/0285257 A1
(43) Pub. Date: Sep. 24, 2026

(54) WINDSCREEN-WIPER BLADE COMPRISING A VARIABLE PROFILE WITH MULTIPLE VERTEBRAS

(71) Applicant: VALEO SYSTEMES D'ESSUYAGE, La Verriere (FR)

(72) Inventors: Gerald CAILLOT, La Verriere (FR); Jean Michel JARASSON, La Verriere (FR); Vincent IZABEL, La Verriere (FR); Alexandre FILLOUX, La Verriere (FR)

(73) Assignee: VALEO SYSTEMES D'ESSUYAGE, La Verriere (FR)

(21) Appl. No.: 18/996,083

(22) PCT Filed: Jul. 21, 2023
(86) PCT No.: PCT/EP2023/070378

§ 371 Date: Jan. 17, 2025

(30) Foreign Application Priority Data
Jul. 21, 2022 (FR) FR2207511

(51) Int. Cl. B60S 1/38

(52) U.S. Cl. CPC B60S 1/3874; B60S 1/3849; B60S 2001/3817

(57) ABSTRACT

The invention relates to a windscreen-wiper blade for a motor vehicle including at least one wiping strip intended to be in contact with a glazed surface, a stiffening member including at least two vertebras joined end-to-end by their longitudinal end, each vertebra being attached to a connector rigidly connected to the stiffening member, a central mounting hinged to each of the connectors. The windscreen-wiper blade also includes a variable profile suitable for distributing a clamping pressure evenly over the entire length of the windscreen-wiper blade.

### TECHNICAL FIELD

The present invention relates to a windshield wiper for a vehicle, in particular a motor vehicle.

### BACKGROUND OF THE INVENTION

Known in particular is a windshield wiper technology referred to as “flat blade”, comprising a blade rubber which is generally made of elastomer and is held over its entire length. The flat blade is then equipped with at least one longitudinal spline which makes it possible in particular to stiffen the blade rubber, so as to promote the application of this blade rubber to a glazed surface of the motor vehicle. In addition, this longitudinal spline is bent and its bend makes it possible to give the blade rubber a curved shape while at the same time keeping it pressed against the glazed surface. In other words, it is the longitudinal spline which generates the curvature of the blade rubber, and therefore which creates the distribution of the pressure exerted by the blade on the windshield.

The windshield wiper is generally attached to an arm which is driven by a motor in an angular reciprocating motion. The blade rubber is then intended to wipe the glass pane of the vehicle by scraping it in the course of these angular reciprocating motions, thereby making it possible to discharge water by removing it from the driver's field of view.

However, flat blades have the drawback of not correctly wiping the windshield, in particular because the forces are not distributed uniformly along the windshield wiper.

This is all the more important on windshields that exhibit marked variations in radii of curvature, such as complex/panoramic windshields, in particular for trucks or vehicles equipped with a single monoblade (positioned at the Y0 position of the vehicle). This problem is also emphasized for windshield wipers of great length (>800 mm), which for example buses are equipped with.

Specifically, in these instances, the limits reached by such a windshield wiper structure, in which the spline is defined according to a compromise for all of the zone that is wiped, are seen. This compromise leads to a lack of local effectiveness, manifested by uplifts at the ends, and/or local overpressures.

In addition, when the length of the windshield wiper is considerable, the latter may exhibit problems of mechanical stiffness, in particular in terms of the resistance to lateral shocks, which are amplified at the spline/connector connection by the length of the wiper.

### SUMMARY OF THE INVENTION

The invention has in particular the aim of overcoming these drawbacks, by providing a windshield wiper for a motor vehicle having a variable profile, that is to say of which the shape has a structural profile resulting in a variable pressure profile in the splines, such that the application of the blade rubber to the windshield is uniform and that the distribution of the pressures exerted by the blade rubber on the windshield is uniform when the blade rubber is pressed against the windshield.

As a result, the subject matter of the invention relates to a windshield wiper for a motor vehicle, comprising at least one blade rubber intended to be in contact with a glazed surface, a stiffening member comprising at least two splines that have their longitudinal ends placed against each other, each spline being attached to a connector which is secured to the stiffening member, and a central mount articulated on each of the connectors, wherein the windshield wiper has a variable profile capable of distributing an application pressure uniformly over the entire length of the wiper.

Such a windshield wiper exhibits better performance and makes it possible to obtain a uniform wiping quality over all of the glazed surface, irrespective of the variations in the curvature of the windshield, by virtue of a transmission of the force exerted by the arm over the entire length of the windshield wiper that makes it possible to better locally manage the variations in shape of the windshield and reduce/avoid the lack of pressure at the ends of the wiper, or the overpressures.

According to various features of the invention, taken alone or in combination, it may be provided that:
the central mount has a pivot connection intended to be connected to a drive arm, the pivot connection being disposed longitudinally off-center on the central mount. at least one connector is positioned off-center on a spline.
at least one spline has at least one different geometric feature to another spline.
the geometric feature is chosen, individually or in combination, from among the following geometric features: geometric shape, length, cross section, radius of curvature.
at least one spline is made from a different material to another spline.
at least one of the splines is asymmetric, making it possible to emphasize the curvature at the end of the wiper.
the asymmetric spline possesses a portion which has:
   a different geometric shape to another portion of the spline; and/or
   a different cross section to another portion of the spline; and/or
   a different radius of curvature to another portion of the spline.
the stiffening member forms a one-piece body going substantially all along the length of the blade rubber and serving as support for said splines. Specifically, the stiffening member longitudinally connects the splines aligned on a single longitudinal axis of the windshield wiper. The stiffening member thus ensures mechanically continuous splines, so as to ensure a continuous curvature of the stiffening member along the windshield wiper, including in its central longitudinal zone, or between two splines. This configuration makes it possible to secure splines that have different structures, in particular which are asymmetric at the sub-wipers, to better locally adapt to the windshield, without imposing a radius of curvature between these splines. In addition, the stiffening member makes it possible to hold the splines together along the length, without requiring a connecting element between the two sub-wipers.
the stiffening member has a groove for slidably mounting the splines.
the stiffening member has a retaining element for attaching the blade rubber.
the stiffening member has at least one deflector attached to an upper part of the stiffening member so as to encapsulate the splines.
the stiffening member has at least three deflectors, two lateral deflectors and one intermediate deflector, encapsulating the splines over the entire length of the stiffening member.
the intermediate deflector has a different shape to the lateral deflectors.
the intermediate deflector interacts with the stiffening member in order to form a connection between a top half-blade and a bottom half-blade.
the windshield wiper also comprises:
   a spraying device configured to spray a washing fluid onto said glazed surface, said spraying device comprising spray orifices,
   a washing fluid distributing device configured for distributing said washing fluid to said spraying device

### BRIEF DESCRIPTION OF DRAWINGS

The invention will be understood better on reading the following description, provided purely by way of example and with reference to the appended drawings, in which:

FIG. 1 is a perspective view of an example of a windshield wiper according to the invention;

FIG. 2 is a perspective view of a part of the wiper in FIG. 1, in particular the stiffening member, the splines, the connectors and the blade rubber;

FIG. 3 is a perspective view of an example of a windshield wiper according to the invention, including three cross sections for viewing the structure of the windshield wiper;

FIG. 4A, FIG. 4B, and FIG. 4C illustrate various possible alternatives for obtaining a variable profile capable of distributing an application pressure uniformly over the entire length of the wiper;

FIG. 5 is a perspective view of an example of a windshield wiper according to the invention, which has an asymmetry related to the offset of the pivot link, the offset of the connectors on the splines, and the different lengths of the splines

It should first of all be noted that the figures set out the invention in detail for implementing the invention, it being, of course, possible for said figures to serve to better define the invention if necessary. However, it should be noted that these figures only set out some of the possible embodiment variants according to the invention.

In the following description, the terms “longitudinal” or “lateral” refer to the windshield wiper. The longitudinal direction corresponds to the main axis of the windshield wiper along which it extends, while the lateral orientations correspond to concurrent straight lines, that is to say straight lines which cross the longitudinal direction, in particular perpendicularly in relation to the longitudinal axis of the windshield wiper in the plane in which it rotates. For longitudinal directions, the terms “outer” or “inner” are defined in relation to an attachment point where the windshield wiper is attached to a drive arm, the term “inner” corresponding to the part where the arm and a half-wiper extend.

Finally, the directions referenced as “upper” or “lower” correspond to orientations perpendicular to the plane of rotation of the windshield wiper, the denomination “lower” containing the plane of the windshield. Where appropriate, the term “inner” or “internal” may refer to the inside of a component or to an inner/internal side of a component, as opposed to the outside of a component, which makes it possible for example to describe visible, or external, aspects of the component, or the outer/external side of the component.

### DETAILED DESCRIPTION OF THE INVENTION

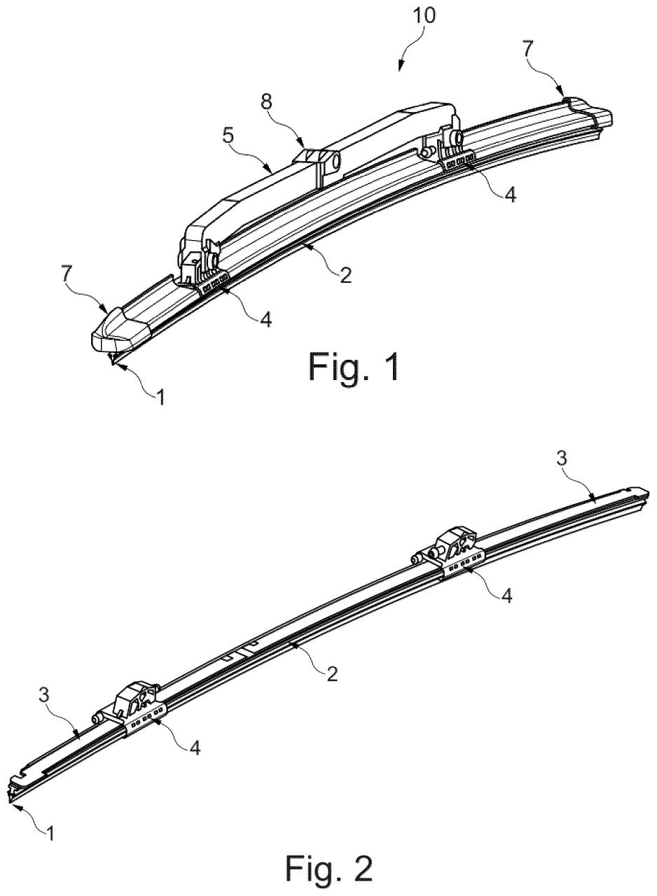

FIG. 1 shows a flat windshield wiper 10 for a motor vehicle. The windshield wiper 10, in this exemplary embodiment, comprises a blade rubber 1 intended to be in contact with a glazed surface, and a stiffening member 2 comprising at least two splines 3 (shown in FIG. 2) that have their longitudinal ends placed against each other. The splines 3 are configured to generate incremental curvatures of the blade rubber 1. Each spline 3 is attached to a connector 4 which is secured to the stiffening member 2.

The windshield wiper 10 also has a central mount 5 articulated on each of the connectors 4. The articulated connection allows the central mount 5 to rotate in relation to the connector 4 in a plane perpendicular to the plane of rotation of the windshield wiper 10. Because the central mount 5 is articulated on at least two connectors 4 that are remote from one another, the pressure force exerted by the drive arm is distributed (evenly if it is centered) along the blade rubber 1 via the connectors 4 and the stiffening member 2.

The central mount 5 has a pivot connection 8 intended to be attached to a drive arm 9 made to perform an angular reciprocating motion by a motor. The wiper blade 1 is then driven by these angular reciprocating motions so as to wipe the glazed surface of the vehicle, in particular by scraping it. In this way, water is discharged by being removed from the glazed surface and thus from the driver's field of view.

The stiffening member 2 is that component part of the windshield wiper that ensures that the blade rubber 1 follows the curvature of a glazed surface such as a windshield of a motor vehicle. Each of the splines 3 creates a distribution of pressure between the blade rubber 1 and the windshield, differentially over the length of the blade rubber 1, so as to promote its application to all of the glazed surface.

According to the invention, the windshield wiper 10 has a variable, for example asymmetrical profile able to distribute the application pressure uniformly over the entire length of the windshield wiper 10, which is to say that its shape makes it possible to uniformly distribute the pressures exerted by the blade rubber 1 on the windshield when the blade rubber 1 is pressed against the windshield.

Various possible alternatives for obtaining such a variable profile are described below.

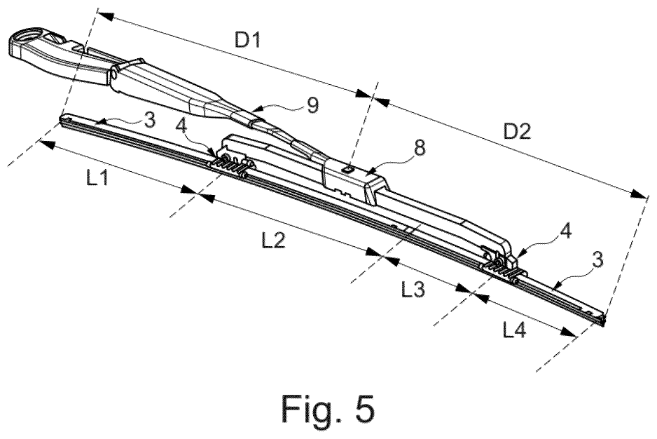

According to a first alternative (FIG. 4A), the variability of the pressure profile is obtained by a position off-center of the pivot connection 8 of the central mount 5. Specifically, by making the pivot connection 8 off-center, making it possible to transmit the pressure exerted by the arm 9 to the windshield wiper 10, the length C1 between the pivot connection 8 and a first end of the central mount 5 is different than the length C2 between the pivot connection 8 and the second end of the central mount 5. In this way, the pressure is distributed non-uniformly over the wiper: the pressure exerted on the shortest part of the wiper is greater than the pressure exerted on the longest part of the wiper. Ultimately, the pressure exerted by the wiper on the windshield has a variable, for example asymmetrical profile. According to this option, and as illustrated in FIG. 5, the length D1 between the pivot connection 8 and a first end of the wiper (first half-wiper) may be different than the length D2 between the pivot connection 8 and the second end of the wiper (second half-wiper).

In this way, varying the length of the half-wipers (and therefore the position of the pivot connection 8) modifies the respective pressure exerted by each of the two half-wipers.

Making the pivot connection 8 of the central mount 5 off-center is only an alternative, and of course this pivot connection 8 may be centered on the central mount 5, and another alternative for obtaining a variable profile is then implemented.

According to a second alternative (FIG. 4B), the variability of the pressure profile is obtained by the position off-center of a connector on a spline.

Each connector 4 is secured to the stiffening member 2. The presence of at least two connectors 4 makes it possible to distribute the force F exerted on the central mount 5 by the drive arm. The two connectors 4 then each transmit some of the force F exerted by the drive arm to the blade rubber 1, in particular via the stiffening member 2 and each spline 3. In general, each connector 4 is disposed longitudinally at the center or substantially at the center of the spline 3 to which it is attached. Half of the force F is then transmitted longitudinally to the center of each of the spines 3 of the stiffening member 2. In this way, the pressure force exerted by the drive arm connected to the central mount 5 is distributed over these two connectors 4, thereby making it possible to distribute this pressure force evenly along the spline 3 and then the blade rubber 1 via the stiffening member 2. Specifically, because of the curvature of the blade rubber 1 and because the central mount 5 is articulated on at least two connectors 4 that are remote from one another, the pressure force exerted by the drive arm is distributed evenly along the blade rubber 1 via the connectors 4 and the stiffening member 2.

However, by making the position of the connector 4 on one spline 3 off-center, the length L1 (L3 in FIG. 4B) between the connector 4 and a first end of the spline 3 is different than the length L2 (L4 in FIG. 4B) between the connector 4 and the second end of the spline 3. In this way, the pressure exerted on the shortest part of the spline is greater than the pressure exerted on the longest part of the spline. Ultimately, the pressure exerted by the wiper on the windshield has a variable, for example asymmetrical profile.

According to a third alternative (FIG. 4C), the variability of the pressure profile is obtained by using splines that have different geometric features or comprise different materials. For example, at least one spline may:
have a different geometric shape; and/or
have a different length (see FIG. 4C, where L1+L2 is different than L3+L4); and/or
have a different cross section; and/or
have a different radius of curvature; and/or
comprise a different material.

The splines 3 are made of a material for stiffening the blade rubber 1 and transferring the pressure exerted by the arm into a distribution of pressure applied to the windshield by the blade rubber. This material is for example metallic. According to one example of this embodiment variant, at least one spline is made from a different material to another spline, in order to further refine the local pressure applied to the windshield by the blade rubber 1.

The splines 3 of the stiffening member 2 have a radius of curvature (RC) for giving the blade rubber 1 a shape adapted to that of the windshield. According to one example of this embodiment variant, at least one spline has a different radius of curvature to another spline, in order to further refine the local pressure applied to the windshield by the blade rubber 1.

According to one example of this embodiment variant, at least one spline has a different length to another spline, in order to further refine the local pressure applied to the windshield by the blade rubber 1.

The presence of multiple splines 3 having different features, such as the shape, the cross section, the length, the radius of curvature and the material, makes it possible to place constraints on the shape of the blade rubber 1 over its entire length, and to apply a constant force along the blade rubber 1, in order to improve the scraping and wiping of the windshield.

According to a fourth alternative (not illustrated), the variability of the pressure profile is obtained by the presence of at least one spline having an asymmetric profile. In this way, the asymmetric spline exerts a pressure on the blade rubber 1 according to an asymmetric profile.

For example, the radius of curvature of a spline may be different on one side or the other: one spline portion, for example one half-spline, having a given radius of curvature, and the other portion (the other half-spline) having a different radius of curvature. It goes without saying that the asymmetry of a spline may result from different variants. For example, at least one spline portion may have:
a different geometric shape to another portion of the spline; and/or
a different cross section to another portion of the spline; and/or
a different radius of curvature to another portion of the spline.

It is clear to a person skilled in the art that the four alternatives for the variability of the pressure profile that were described above can be taken individually or in combination because the four embodiment variants can be combined with one another.

For example, FIG. 5 illustrates a windshield wiper in which:
D1≠D2: the pivot connection 8 is off-center, and therefore the two half-blades have different lengths D1 and D2.
L1≠L2: the connector of the first spline is off-center, and therefore the two half-splines have different lengths L1 and L2.
RC1≠RC2: the two half-splines of the first spline have different radii of curvature RC1 and RC2.
L3≠L4: the connector of the second spline is off-center, and therefore the two half-splines have different lengths L3 and L4.
RC3≠RC4: the two half-splines of the second spline have different radii of curvature RC3 and RC4.
L1+L2≠L3+L4: the first spline, of length L1+L2, has a different length to the second spline of length L3+L4.

According to a particular embodiment, and as shown in the figures, the stiffening member 2 forms a one-piece body going substantially all along the length of the blade rubber 1 and serving as support for said splines 3. Such a stiffening member 2 makes it possible, in one piece, to distribute the pressure applied by the arm to various parts of the wiper 10, depending on the curvature of the windshield intended to be scraped by the blade rubber 1.

According to one exemplary embodiment, the one-piece body is made of plastic, preferably a flexible plastic.

The stiffening member 2 makes it possible to support splines of various lengths, various cross sections, various shapes, various radii of curvature, and various materials, in a single structure, thus making it possible to optimize the shape of the one-piece body and therefore of the blade rubber 1.

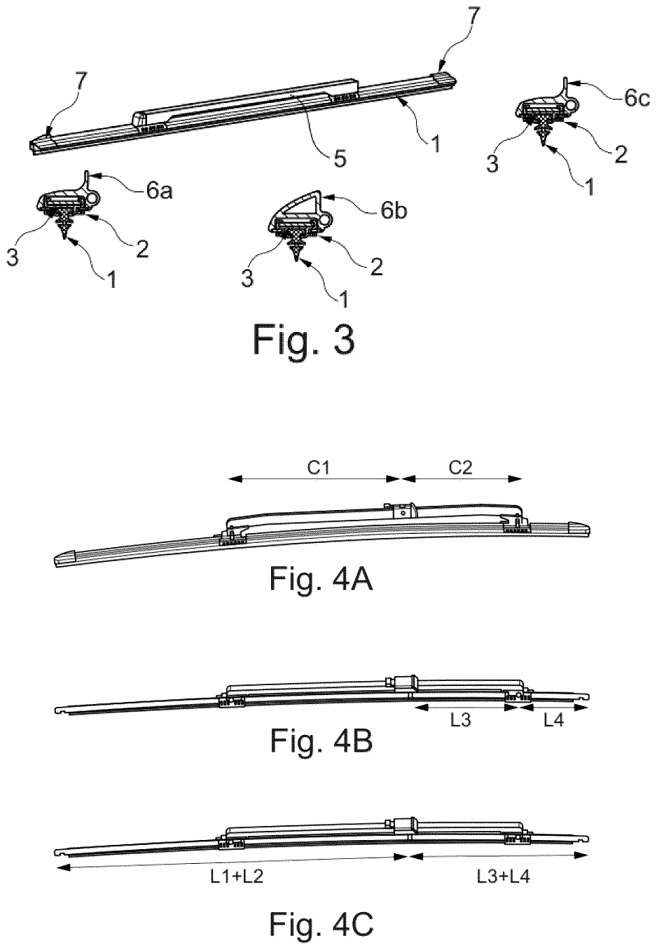

The stiffening member 2 has a lower part intended to face the windshield and an upper part away from the lower part. The lower part of the stiffening member 2 has a retaining element for attaching the blade rubber 1. More specifically, the blade rubber 1 is preferably made of elastomer and is held over its entire length by the stiffening member 2. As illustrated in FIG. 3, which shows an example of a windshield wiper and three cross sections, the stiffening member 2 has a claw which clamps the blade rubber 1, or a channel in which the blade rubber 1 slides.

The upper part of the stiffening member 2 has a location intended to receive the splines 3. The stiffening member 2 distributes the bearing force exerted by the drive arm all along the blade rubber 1. As illustrated in the cross sections in FIG. 3, the upper part of the stiffening member 2 has a groove for slidably mounting the splines 3.

According to one embodiment, the stiffening member 2 has at least one deflector 6 attached to the upper part of the stiffening member 2, thus encapsulating the splines 3.

The deflector 6 makes it possible to use the flow of air to assist in pressing the wiper 10 against the windshield.

According to one embodiment variant, illustrated in particular in FIG. 3, the stiffening member 2 has at least three deflectors, two lateral deflectors 6a and 6c and one intermediate deflector 6b, encapsulating the splines 3 over the entire length of the stiffening member 2. This configuration makes it possible to adapt the aerodynamic shape of the deflectors depending on the curvature of the splines 3, and on the presence of the mount 5.

Thus, according to one example, the intermediate deflector 6b has a different shape to the lateral deflectors 6a, 6c (FIG. 3).

According to one embodiment variant, the intermediate deflector 6b interacts with the stiffening member 2 in order to form a connection between a top half-blade and a bottom half-blade.

Furthermore, FIG. 1 shows that two caps 7 are positioned at the longitudinal ends of the windshield wiper 10, on the stiffening member 2. These two caps 7 have a shape over their entire length that is substantially identical to the lateral deflectors 6a and 6c, but without having a window on their upper face. Each cap 7 makes it possible to integrally cover a longitudinal end of the windshield wiper 10, and more specifically a longitudinal end of the stiffening member 2 and of the lateral deflectors 6a and 6c.

According to one embodiment (not shown), the stiffening member 2 comprises four splines 3 aligned in pairs on a single longitudinal axis and placed, in pairs, next to each other. In other words, two of the splines 3 have their longitudinal ends placed against each other, and two of the other splines are placed next to and parallel to each other. “Next to” is understood to mean that the centers of two splines one next to the other are aligned on a single transverse axis. In this way, the stiffening member 2 comprises four splines 3, with mutually parallel splines 3 and splines 3 aligned on a single longitudinal axis.

According to one embodiment, the windshield wiper 10 also comprises:
a spraying device configured to spray a washing fluid onto said glazed surface, said spraying device comprising spray orifices;
a washing fluid distributing device configured for distributing said washing fluid to said spraying device.

The invention is not limited to the embodiments presented, and further embodiments will be clearly apparent to a person skilled in the art.

Claimed is:

1. A windshield wiper for a motor vehicle, comprising at least one blade rubber intended to be in contact with a glazed surface, a stiffening member including at least two splines that have longitudinal ends placed against each other, each spline being attached to a connector which is secured to the stiffening member, and a central mount articulated on each of the connectors, wherein the windshield wiper has a variable profile capable of distributing an application pressure uniformly over the entire length of the windshield wiper.

2. The windshield wiper as claimed in claim 1, wherein the central mount includes a pivot connection intended to be connected to a drive arm, the pivot connection being disposed longitudinally off-center on the central mount.

3. The windshield wiper as claimed in claim 1, wherein at least one connector is positioned off-center on a spline.

4. The windshield wiper as claimed in claim 1, wherein at least one spline has at least one different geometric feature to another spline.

5. The windshield wiper as claimed in claim 4, wherein the geometric feature is chosen, individually or in combination, from among the following geometric features: geometric shape, length, cross section, radius of curvature.

6. The windshield wiper as claimed in claim 1, wherein at least one spline is made from a different material to another spline.

7. The windshield wiper as claimed in claim 1, wherein at least one of the splines is asymmetric.

8. The windshield wiper as claimed in claim 7, wherein the asymmetric spline possesses a portion which has:
a different geometric shape to another portion of the spline; and/or
a different cross section to another portion of the spline; and/or
a different radius of curvature to another portion of the spline.

9. The windshield wiper as claimed in claim 1, wherein the stiffening member forms a one-piece body going substantially all along the length of the blade rubber and serving as support for the splines.

10. The windshield wiper as claimed in claim 1, wherein the stiffening member has at least three deflectors, two lateral deflectors and one intermediate deflector, encapsulating the splines over the entire length of the stiffening member.
